(19) United States
(12) Patent Application Publication
(10) Pub. No.: US 2007/0134733 A1
(43) Pub. Date: Jun. 14, 2007

(54) Raman signature probes and their use in the detection and imaging of molecular processes and structures

(75) Inventors: Mustapha Haddach, San Diego, CA (US); Gregory S. Naeve, San Diego, CA (US)

Correspondence Address: WILSON SONSINI GOODRICH & ROSATI, 650 PAGE MILL ROAD, PALO ALTO, CA, 94304-1050, US

(73) Assignee: Parallax Biosystems, Inc.

(21) Appl. No.: 10/564,110

(22) PCT Filed: Jul. 9, 2004
(86) PCT No.: PCT/US04/21895

§ 371 Date: Jul. 7, 2006

Related U.S. Application Data
(60) Provisional application No. 60/486,866, filed on Jul. 10, 2003.

(51) Int. Cl. C40B 30/06; C40B 40/04

(52) U.S. Cl. 435/7.2; 436/518

(57) ABSTRACT

Disclosed are methods and materials for detecting and imaging molecular processes and structures. Methods included detecting and imaging by contacting targets with RSPs, irradiating the target, and collecting and analyzing the spectra produced by the RSPs.

### FIELD OF THE INVENTION

The invention relates to the synthesis of Raman Signature Probes (RSPs) and their use as diagnostic tools in analytical and imaging applications. The invention also relates to the synthesis of acetynyl containing, deuterium containing, cyano-containing, nitro-containing or halogen-containing RSPs and their detection and use as mapping or imaging agents in vitro or in vivo.

### BACKGROUND OF THE INVENTION

The detection and quantification of ligand molecules in complex mixtures containing small amounts of the ligand molecule and large numbers and amounts of other materials is a continuing challenge. As more interest is focused upon the roles of biological molecules in physiology and disease processes, a need remains for the rapid accurate detection of biological molecules such as nucleic acids and proteins.

Several methods have been used for the detection of nucleic acids and proteins. Typically, a reporter group is added to an analyte molecule thereby increasing the ability of an analytical method to detect that molecule. Reporter groups can be radioactive, flourescent, spin labeled, and are often incorporated into the analyte during synthesis. Additionally, other types of labels, such as rhodamine or ethidium bromide can intercalate between strands of bound nucleic acids in the assay and serve as reporter groups of hybridized nucleic acid oligomers.

Currently, the detection of ligands is accomplished using a variety of methods, including chromatography, mass spectroscopy, nucleic acid hybridization and immunology. Hybridization and immunological methods rely upon the specific binding of the ligands to detector, or “receptor” molecules. In addition to these methods of detection, several methods have been used to detect nucleic acids using Raman spectroscopy. See, e.g., U.S. Pat. Nos. 5,814,516; 5,783,389; 5,721,102; and 5,306,403.

Recently, Raman spectroscopy has been used to detect proteins. See, e.g., U.S. Pat. Nos. 5,266,498 and 5,567,628 which provide an analyte that has been labeled using a Raman active label and an unlabeled analyte in the test mixture. However, there are many drawbacks to requiring the introduction of reporter groups into the analyte. For example, the methods almost always require additional steps, and because specific Raman labels must be provided for each type of assay system used, the properties of the analytes must be determined in advance of the assay.

A variety of probes, ranging from antibodies used for histological stains to small molecule ligands, have also been developed for use in positron emission tomography (PET) for the detection of proteins in biological assay or imaging systems. These conventional probes are designed to specifically bind to a protein or mimic biological activity and are used as tools in research and clinical applications. In order to follow their fate in an assay or imaging system, the conventional probes are ‘tagged’ to allow them to later be detected. The most common forms of these tags are based on radioactive or fluorescence methods of detection. However, there are drawbacks to each of these types of tags. For example, radioactive labels have inherent environmental health issues and the number of radioactive isotopes available for labeling probes is limited. Furthermore, radioactive isotopes have short half-lives and are often difficult to synthetically incorporate onto the probe. Fluorescent labels are relatively large organic compounds with a specific structural conformation that is necessary to maintain in order to generate their fluorescent signal. The size and structural constraints restrict their ability to be readily added to probe molecules, limiting their usefulness.

Raman Spectroscopy

Raman spectroscopy involves the use of electromagnetic radiation to generate a signal in an analyte molecule. According to a theory of Raman scattering, when incident photons having wavelengths in the near infrared, visible or ultraviolet range illuminate a certain molecule, a photon of that incident light can be scattered by the molecule, thereby altering the vibrational state of the molecule to a higher or a lower level. The vibrational state of a molecule is characterized by a certain type of stretching, bending, or flexing of the molecular bonds. The molecule can then spontaneously return to its original vibrational state. When the molecule returns to its original vibrational state, it can emit a characteristic photon having the same wavelength as the incident photon. The photon can be emitted in any direction relative to the molecule. This phenomenon is termed “Raleigh Light Scattering.”

A molecule having an altered vibrational state can return to a vibrational state different from the original state after emission of a photon. If a molecule returns to a state different from the original state, the emitted photon can have a wavelength different from that of the incident light. This type of emission is known as “Raman Scattering.”

If, a molecule returns to a higher vibrational level than the original vibrational state, the energy of the emitted photon will be lower (i.e., have a longer wavelength) than the wavelength of the incident photon. This type of Raman scattering is termed “Stokes Shifted Raman Scattering.” Conversely, if a molecule is in a higher vibrational state, upon return to the original vibrational state, the emitted photon has a lower energy (i.e., have a shorter wavelength). This type of Raman Scattering is termed “Anti-Stokes-Shifted Raman Scattering.” Because many more molecules are in the original state than in an elevated vibrational energy state, typically the Stokes-shifted Raman scattering will predominate over the anti-Stokes-shifted Raman scattering. As a result, the typical shifts of wavelength observed in Raman spectroscopy are to longer wavelengths. Both Stokes and anti-Stokes shifts can be quantified using a Raman spectrometer.

When the wavelength of the incident light is at or near the frequency of maximum absorption for that molecule, absorption of a photon can elevate both the electrical and vibrational states of the molecule. The efficiency of Raman scattering of these wavelengths can be increased by as much as about 1 times the efficiency of wavelengths substantially different from the wavelength of the absorption maximum. Therefore, upon emission of the photon with return to the ground electrical state, the intensity of Raman scattering can be increased by a similar factor.

Additionally, when Raman active molecules are excited near to certain types of metal surfaces, a significant increase in the intensity of the Raman scattering can be observed. The metal surfaces that exhibit the largest increase in Raman intensity comprise minute or nanoscale rough surfaces, such as those coated with minute metal particles. For example, nanoscale particles such as metal colloids can increase intensity of Raman scattering to about 10⁶ times or greater, than the intensity of Raman scattering in the absence of metal particles. This effect of increased intensity of Raman scattering is termed “surface enhanced Raman scattering.” The combined effects of surface enhancement and resonance on Raman scattering is termed “surface enhanced resonance Raman scattering.” The combined effect of surface enhanced resonance Raman scattering can significantly increase the intensity of Raman scattering.

Commonly used methods for detection of specific nucleic acid sequences can be too slow for medical diagnostic or forensic purposes, where it is often very important for results of tests to be available rapidly. For example, existing methods for detecting and identifying biological pathogens, however they are typically slow and technically complicated processes. For example, traditional methods of detection require cellular outgrowth as part of the protocol. This step requires hours to days, and the selected growth medium can favor the growth of bacteria with specific phenotypes, resulting in a bacterial population after outgrowth that is not representative of the bacterial population in the original sample.

More recently, several other approaches have been developed that eliminate drawbacks associated with the traditional methods. Some of these methods use different probe technologies for microbial detection, such as nucleic acid-based probes or antibody-based probes. Although these technologies offer several advantages over traditional methods, they still present several limitations. Disadvantages of nucleic acid-based probes include the difficulty in the isolation and “clean-up” of the DNA sample, poor stability, and interference from related sequences or products. A key issue in developing antibody-based probes for microbial cell labeling, concerns the target protein. This protein must be accessible to the probe, ideally exposed on the cell surface in high copy number, to enable polyvalent binding of the antibody probe to the microbe. There are several additional issues unique to the antibody-based approach including nonspecific binding, degradation over time, low reproducibility, and the challenge of producing pure target proteins for generating specific antibodies. Furthermore, the ability to detect biologics in real-time using either nucleic acid or antibody-based detection methods is limited.

Thus, there clearly remains a need for reliable and precise methods for diagnosing medical abnormalities and for assessing the general condition of body tissues. While any approach that offers early and reliable warning of medical problems has some utility, noninvasive methods offer many advantages. Anticipation by a patient of pain and scarring associated with invasive procedures can cause delays in seeking medical attention. There is also a myriad of inconveniences, risks and difficulties associated with direct collection and contact with patient body fluids. For these reasons, there has been intense scientific and engineering research into devising noninvasive approaches for the assessment and diagnosis of medical conditions.

Additionally, an efficient screening method useful for identifying small molecules capable of binding to target proteins without prior knowledge of a native ligand or the inherent activity or function of the target protein, thus useful for identifying ligands for orphan receptors, is still needed. In addition, there is a need for a screening system for identifying small-molecule interactors of membrane proteins, which are often not good candidates for rational drug design. There is also a need for a system for identifying compounds that differentially bind to proteins as a function of their activation state without modulating the activity of the protein itself. Additionally, there is a need for activity-dependent compounds that may be used as histological and biochemical markers for mapping and observing protein activity in vitro and in vivo to validate the value of the protein as a therapeutic target, or that may be used as reagents to investigate or substantiate the mechanism of action for a given drug compound or candidate.

Out of efforts aimed at addressing such needs, various solutions have now been discovered, which are summarized and described below.

### SUMMARY OF THE INVENTION

Raman Signature Probes (RSPs) and methods of using them are provided herein. In some embodiments the RSP is a small organomolecule that binds to a target, wherein the small organomolecules has a Raman signature that is distinguishable from the background. In other embodiments the RSP is a peptide that binds to a target, wherein the peptide has a Raman signature that is distinguishable from the background. In still other embodiments, the RSP specifically binds to a target. In various embodiments, the RSP comprises one or more chemical groups selected from cyano, nitro, amide, ester, ether, olefin, sulphoxide, sulphite, sulphinic acid, sulphinic ester, sulphone, sulphonamide, thiol, carboxylic acid, or alkynyl group.

Methods for detecting a target comprising (a) contacting the target with an RSP, (b) irradiating the RSP with a laser, and (c) collecting and analyzing the Raman spectra emitted from the target, are provided herein. In some embodiments, the RSP specifically recognizes and binds the target. In other embodiments, the RSP is a small organomolecule with a Raman signature that is distinguishable from the complex. In some embodiments, the RSP is complexed to the target when it is irradiated. In other embodiments, the RSP is eluted from an RSP-complex prior to irradiation.

Methods for preparing an RSP, comprising:
(a) selecting a ligand for use as an RSP by a process comprising: (i) combining in solution a ligand with a target sample under saturating binding-reaction conditions to yield a mixture containing a target-ligand complex; (ii) analyzing the isolated complex; and (iii) elucidating the ligand's structure; and
(b) preparing the RSP by: (i) synthesizing the selected ligand if the ligand contains a Raman signature that is distinguishable from the background, or (ii) synthesizing an analog of the ligand that has a distinguishable Raman signature if the ligand does not contain a Raman signature that is distinguishable from the background, are provided herein.
   In some embodiments, the ligand contains at least one deuterium, halogen, cyano, nitro, amide, ester, ether, olefin, sulphoxide, sulphite, sulphinic acid, sulphinic ester, sulphone, sulphonamide, thiol, carboxylic acid, or alkynyl group. In other embodiments, the structural analog of the ligand incorporates one or more halogen, cyano, nitro, or alkynyl groups is synthesized. In yet other embodiments, the RSP is used as an imaging reagent in a process comprising: (i) administering the RSP to a subject; (i) obtaining a biological sample from the subject; and (iii) quantitatively detecting for the presence of the RSP in the biological sample. In still other emobodiments, the isolated complex is analyzed using Raman spectroscopy; CARS; SERRS; or SERS.

Methods for preparing an RSP, comprising:
(a) selecting a ligand for use as an RSP by a process comprising: (i) combining in solution a ligand with a target sample under saturating binding-reaction conditions to yield a mixture containing a target-ligand complex; (ii) analyzing the isolated ligand; and (iii) elucidating the ligand's structure; and
(b) preparing the RSP by: (i) synthesizing the selected ligand if the ligand contains a Raman signature that is distinguishable from the background, or (ii) synthesizing an analog of the ligand that has a distinguishable Raman signature if the ligand does not contain a Raman signature that is distinguishable from the background are provided herein. In some embodiments, the ligand contains at least one deuterium, halogen, cyano, nitro, amide, ester, ether, olefin, sulphoxide, sulphite, sulphinic acid, sulphinic ester, sulphone, sulphonamide, thiol, carboxylic acid, or alkynyl group. In other embodiments, a structural analog of the ligand incorporates one or more deuterium, halogen, cyano, nitro, amide, ester, ether, olefin, sulphoxide, sulphite, sulphinic acid, sulphinic ester, sulphone, sulphonamide, thiol, carboxylic acid, or alkynyl group is synthesized. In yet other embodiments, the RSP is used as an imaging reagent in a process comprising: (i) administering the RSP to a subject; (ii) obtaining a biological sample from the subject; and

(iii) quantitatively detecting for the presence of the RSP in the biological sample. In still other emobodiments, the isolated complex is analyzed using Raman spectroscopy, CARS; SERRS; or SERS.

Methods for imaging a target comprising: (a) contacting the target with the RSP; (b) irradiating the target with a source of Laser light; and (c) collecting and analyzing Raman spectra emitted from the target, are provided herein. In some embodiments, the RSP specifically recognizes and binds the target. In other embodiments, the RSP is a small organomolecule or a peptide (such as CRF, MCH, PPAR, VEGF, GnRH, or bradykinin). In various embodiments, the imaging is performed using Raman spectroscopy such as CARS, SERRS, or SERS.

Methods for imaging a target comprising: (a) contacting the target with an RSP, wherein the RSP comprises at least one group selected from halogen, cyano, nitro, and alkynyl; (b) irradiating the target with a source of laser light; and (c) collecting and analyzing Raman spectra emitted from the target, are also provided herein.

### BRIEF DESCRIPTION OF THE DRAWINGS

FIG. 1 is a SERS spectra of compound 1A.

FIG. 2 shows the detection of Fab I using compound 1A.

FIG. 3 shows the detection of Fab I expressing bacteria using compound 1A.

### DETAILED DESCRIPTION OF THE INVENTION

Raman spectrum of particular compound depends on the vibrational properties of specific chemical bonds and is thus molecularly specific. The chemical bonds of a particular compound can be used then as tracers to tag a protein and determine its location, function, and quantity. Because molecules containing unique chemical functional groups such as, e.g., cyano, acetylenic, nitro, C-D, andlor C-halogen (e.g., C—F, C—Cl, C—Br, and C—I) bonds, do not exist in biological systems, they can be advantageously used as imaging or mapping reagents. Various chemical functional groups such as, for example, cyano groups, acetylenic groups, nitro groups, C-D bonds, and C-halogen bonds, are commonly used in structure activity-relationship studies in drug discovery research and also have distinct frequencies in the Raman spectrum, typically with moderate to strong signal intensities. See, e.g., Schrader B. Infrared and Raman Spectroscopy, VCH Weinheim, Germany, (1995).

The Design of RSPs

Various approaches to making a RSP are discussed herein. In one embodiment, existing molecules are modified to incorporate a unique chemical functional group, which results in a detectable Raman signature. These existing molecules may include those that are currently used as probes with conventional detection methods, such as fluorescence and radioactive based methods, or they may be molecules that are potentially useful but have yet to be appropriately labeled for use in a conventional detection method.

Molecules that can be optimized for use in specific applications, e.g., research diagnostic assays or imaging studies, are identified. In some embodiments, these molecules are identified by screening chemical compound libraries for molecules that bind to the protein target of interest. Conventional screening methods useful in the present invention are known by those of ordinary skill in the art and include, for example, fluorescence or mass spectroscopy based methods.

In various embodiments described herein, once initial candidate molecules are identified they can be optimized for the protein target using structure activity relationships as known in the art of medicinal chemistry to generate molecules with desired binding, specificity, and Raman signature necessary to make a probe suitable for the application of interest. The molecules that demonstrate high binding affinity for the target protein can be used as RSPs if they contain at least one chemical functional group capable of providing a Raman signature that is distinguishable from the background. For example, the unique chemical functional group may be one or more groups selected from cyano-group, acetylenic group, nitro-group, C-D bond, or C-halogen bond.

In other embodiments described herein, candidate molecules which are identified, but don't contain a Raman signature that is distinguishable from the background are modified by introducing at least one chemical functional group capable of providing a Raman signature that is distinguishable from the background. Such functional groups, include, for example cyano-groups, acetylenic groups, nitro-groups, C-D bonds, or C-halogen bonds. Depending on a variety of factors, such as the candidate molecule and the chemical route used to make it, one of ordinary skill in the art will be able to determine which functional group to add. For example, in order to generate a candidate molecule with the desired binding, specificity, and/or Raman signature necessary, a cyano, nitro, acetylenic, C-D, or C-halogen bond may be added to the ligand. The specific functional group added will depend on the application of interest, the ligand being modified, and the chemical or biological route used to synthesize the ligand. Nevertheless, coupled with the information provided herein, one of ordinary skill in the art would know how to select an appropriate functional group to make a RSP.

Analytical and Imaging Reagents

There are many potential uses for RSPs that range from applications in diagnostic assay kits to novel noninvasive imaging techniques. In some embodiments of the invention, RSPs are used to provide functional disease related information, such as the visualization of a drug in action or the tracking of a disease process in real time. Thus, the various RSPs of the present invention significantly expand the versatility of detection and/or image analysis in applications ranging from drug discovery to clinical pathology.

In one embodiment of the present invention, RSPs are used in diagnostic applications whereby the approach is amenable to assays wherein the RSP is added to cell or cell extracts as a method to quantitatively detect the presence of a target protein that the RSP binds to. In one example, during the course of a therapeutic treatment, a blood sample is drawn and the presence or absence of a specific protein marker is tested whereby detection of the specific protein occurs via the binding of a specific RSP, which is quantified. In a further embodiment of the present invention, the binding of a specific RSP is quantified using Raman spectroscopic measurements.

In another embodiment of the present invention, RSPs are used as imaging reagents. In this embodiment, the RSPs act as tags to detect protein markers in histological analyses of tissue biopsies. In other embodiments, the RSPs are used as probes for non-invasive detection of cellular markers in live animals. In various other embodiments, the RSPs are used as reagents that can be administered in vivo, bind to their target protein, and used to visualize their distribution throughout the tissue of interest. For example, an RSP designed to bind to a protein found only in prostate cancer may be administered to patient and used to non-invasively image the presence or absence of the this prostate specific protein. In still other embodiments, the analysis can be performed ex-vivo or in situ. The ability to diagnose diseases in this fashion would minimize the need to perform painful biopsies, which can lead to earlier detection and evaluation of appropriate treatment regimens.

In some embodiments, RSPs are used to detect both primary tumors and metastatic tumors, as well as to monitor cancer associated physiological events, for example folate can be modified to RSP by converting folate to folate-containing deuterium, and can used for imaging by targeting the folate receptor, which is overexpressed by many tumor types, particularly ovarian cancer (S. Wang etal. Bioconjugate Chem. 1996, 7, 56-62). RSPs can also be used to track tumor specific protein markers, such as Nuclear Matrix Proteins, which are potential markers for preneoplastic and cancer lesions (Coffey D., Clincal Cancer Research 2002, 8, 3031-3033).

In various embodiments, the RSPs are used for the detection of pathogens. In other embodiments, the RSPs are used for the detection of bacteria. In still other embodiments, the RSPs are used for the detection of prions. Additionally, RSPs can be used to determine the biodistribution and pharmacokenitic of a drug as well as to answer specific effects of pharmalogical interventions

To more readily facilitate an understanding of the invention and its preferred embodiments, the meanings of terms used herein will become apparent from the context of this specification in view of common usage of various terms and the explicit definitions of other terms provided in the glossary below or in the ensuing description.

Glossary

The terms “comprising,” “including,” “containing,” and “such as” are used herein in an open, non-limiting sense.

“Small organomolecule” means an organic compound having a molecular weight of 2,000 Daltons or less. In some embodiments, the small organomolecule will have a molecular weight of 600 Daltons or less.

The term “target” includes, e.g., cells, cellular fractions (cell walls, membranes, nuclear samples, cytosol samples, etc.), agonists and antagonists of receptors or other binding proteins (including partial agonists and partial antagonists), transferrin, c-kit, viral receptor ligands, cytokine receptors, chemokine receptors, interleukin receptors, immunoglobulin receptors and antibodies, cadhereins, integrins, selecting, toxins and venoms, viruses, bacteria (e.g., Escherichia coli, Salmonella, and Bacillus), prions, viral epitopes, hormones (e.g., peptide hormones, protein hormones, opiates, steroids, etc.), intracellular receptors, peptides, retro-inverso peptides, polymers of alpha, beta, or omega; amino acids (D- or L-), enzymes, enzyme substrates, cofactors, drugs, lectins, sugars, nucleic acids (both linear and cyclic polymer configurations), oligosaccharides, proteins, phospholipids and antibodies, any commercially available or published biological sample or biological molecule, and any molecule whose presence, absence or change in concentration, conformation, activity, or any other property is indicative of any disease or condition. Target also includes any portion, modification, or analogs thereof. Targets can also include synthetic polymers such as heteropolymers in which a known drug is covalently bound to any of the above, such as polyurethanes, polyesters, polycarbonates, polyureas, polyamides, polyethyleneimines, polyarylene sulfides, polysiloxanes, polyimides, and polyacetates.

The term “ligand,” means any component of a sample that binds to a target which is to be detected or quantitatively determined. Examples of ligands include proteins, such as hormones (e.g., steroids and lipids) and other secreted proteins, enzymes, and cell surface proteins; glycoproteins; peptides; small organomolecules including natural products and drug-like compounds; polysaccharides; antibodies (including monoclonal or polyclonal Ab and portions thereof); nucleic acids; drugs; toxins; viruses or virus particles; portions of a cell wall; and other compounds possessing epitopes. In some embodiments, ligands used are from a library that is organized into lipophilic molecules, anionic molecules, cationic molecules, and hydrophilic molecules.

The phrase “Raman Signature Probe” or “RSP” means a molecular probe that can specifically tag a target to determine their location, function, and/or quantity. RSPs are capable of being detected based on their distinct Raman signatures. For example, RSPs can include one or more chemical functional groups such as cyano, nitro, halogen, deuterium, alkynyl groups, and the like. RSPs include, for example, any drug-like ligand with a distinct Raman signature. The term “distinct Raman signature” as used herein means that the Raman signal for the RSP is able to be distinguished from the background. For example, one or more characteristic signals can be identified within the overall Raman spectra.

“Raman spectroscopy” and “Raman” include, e.g., CARS, SERS, SERRS, resonance raman spectroscopy, and the like.

“Eluant” refers to a medium or reagent used to wash away unbound molecules.

“Aryl” (Ar) refers to a monocyclic, or fused or spiro polycyclic, aromatic carbocycle (ring structure having ring atoms that are all carbon) having from 3 to 12 ring atoms per ring. Illustrative examples of aryl groups include the following moieties: 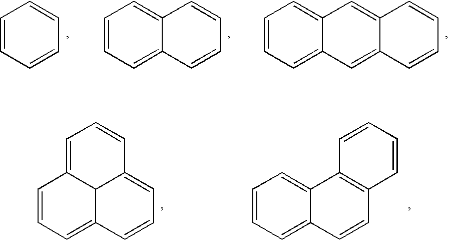
and the like.

“Heteroaryl” (heteroAr) refers to a monocyclic, or fused or spiro polycyclic, aromatic heterocycle (ring structure having ring atoms selected from carbon atoms as well as nitrogen, oxygen, and sulfur heteroatoms) having from 3 to 12 ring atoms per ring. Illustrative examples of aryl groups include the following moieties: 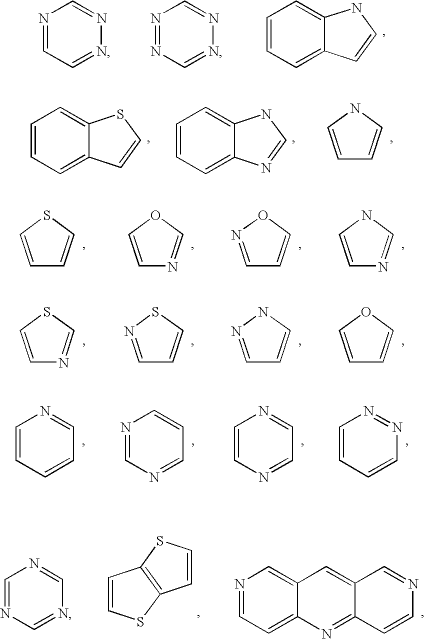
and the like.

To further facilitate an understanding of the invention and its preferred embodiments, publications are cited that describe, e.g., various techniques, apparatus, protocols, and the like that are known in the art. For the sake of brevity, the disclosures of the publications cited herein are incorporated by reference.

### DESCRIPTION OF PREFERRED EMBODIMENTS OF THE INVENTION

The RSPs used for the detection of pathogens, cancerous tissue, or other known diseases, conditions, or medical disorders will be developed either from existing molecules that specifically bind to the target of interest or they will be identified from libraries of small molecules or peptides that can later be chemically optimized as RSPs. Various assays and synthetic optimization methods are known within the art. Thus, the assay format and optimized method of detection will be dependent on the type of sample being analyzed along with the speed and sensitivity requirements.

The following sections describe exemplary materials, methodologies and procedures that may be used in the methods of the invention.

Target Sample

The target sample may include a single protein or a protein fragment or peptide. The source of the target protein may be naturally occurring (e.g., a cell line or tissue) or generated using recombinant gene express techniques. In one embodiment, the target protein is derived or purified from a source expressing the protein. Exemplary membrane proteins that may be used include membrane-bound receptors and ion channels, such as GPCRs, receptor tyrosine kinases, and transporters.

Identification of RSPs

Methods wherein a target sample, which may be a purified membrane protein, is exposed to screening samples containing one or more small organomolecules, which may be, e.g., library of compounds, natural products, or peptides in a mixture with other compounds, in solution under conditions that promote specific binding to the protein are provided herein. The protein-small organomolecule complex is removed from the mixture using a suitable separation technique, such as filtration through a membrane or separation through an affinity property of the protein. The resulting purified protein-small organomolecule complex is then subjected to mass spectrometry (MS), preferably using electrospray ionization (ESI), to directly detect and characterize small organomolecule ligands that bind to a protein target. The resulting mass signature of the small organomolecule is used to further characterize and identify the specific compound from the initial sample. The format of the separation (e.g., affinity isolation) and subsequent mass spectrometry is preferably designed for multi-well analysis, e.g., using 96- or 384well formats. In one embodiment, the screening method of the invention comprises the steps described as follows. First, a target sample of purified membrane protein is mixed and incubated with a screening sample containing a small organomolecule to form a reaction mixture, under conditions conducive to ligand/protein complex formation in solution. The mixture is then exposed in the solution to different adsorbents under different selectivity conditions. The retained protein is detected by mass spectroscopy, identifying conditions under which the target is retained. Samples containing protein/small organomolecule complexes are exposed to an adsorbent under the identified conditions to allow retention of the complex. Unbound agents or materials are then removed from the reaction mixture, after washing with a suitable appropriate eluant. The complex is then analyzed using mass spectrometry.

The binding of the small organomolecules detected using MS may be subsequently confirmed in secondary mass spectrometry, binding, and/or functional assays. Examples of secondary assays include alternative binding assays, biochemical assays, cell-based reporter assays, ELISA-based assays, and in vivo pharmacological testing. The pharmacological profile of a molecule may thus be determined to characterize its specificity (i.e., affinity for a particular protein target over others), binding affinity, and effects on protein function.

In another embodiment, a ligand binding assay is used to identify Raman Signature Probes (RSPs). RSPs are selected or derivatized to contain one or more C-halogen bond yielding F-RSPs or Cl-RSPs or Br-RSPs or I-RSPs, or one or more cyano group, nitro group, deuterium group, or acetylyl group yielding cyano-containing RSPs, nitro-containing RSPs, deuterium-containing RSPs, or acetylyl-containing RSPs, which are preferably detected using coherent Raman spectroscopy or Infrared spectroscopy. In a further preferred embodiment, a halogen containing RSP, cyano-containing RSP, nitro-containing RSP, deuterium-containing RSP, or acetylyl-containing RSP is used as an imaging agent in vitro or in vivo.

Methods wherein the small organomolecule is extracted from the protein-small organomolecule complex using a suitable extraction technique, purified, and then subjected to mass spectrometry (MS), preferably using electrospray ionization (ESI), to directly detect and characterize small organomolecule ligands that bind to a protein target are also provided herein. The resulting mass signature of the small organomolecule is used to further characterize and identify the specific compound from the initial sample. The format of the separation (e.g., affinity isolation) and subsequent mass spectrometry is preferably designed for multi-well analysis, e.g., using 96- or 384-well formats.

Screening Sample

Examples of small organomolecules that may be identified with the inventive screening process include peptides, combinatorial compounds, and natural products or extracts such as polyketides, terpenes, alkaloids, and quinines. The small organomolecule may be one component of a mixture, such as found in natural samples, extracts, and products, such as extracts of terrestrial and marine plants, cells from higher animals including humans, eubacteria, actinomycetes and other bacteria, microbial fermentation broths, filamentous and non-filamentous fungi, protozoa, algae, archaebacteria, worms, insects, marine organisms, sponges, corals, crustaceans, viruses, phages, tissues, organs, blood, soil, sea water, fresh water, humus, detritus, manure, mud, and sewage. The mixture may also contain other small molecules as well as molecules of large molecular weight, such as those having a molecular weight of at least 8,000 Daltons, more preferably of at least 10,000 Daltons. Examples of large molecules include proteins as well as complexes of proteins noncovalently bound to small molecules.

Small organomolecules from combinatorial libraries can be obtained from commercial sources or proprietary collections, or synthesized de novo following literature teachings. Exemplary combinatorial chemical libraries include: peptide libraries (see, e.g. U.S. Pat. No. 5,010,175; Furka, Int. J. Pept. Prot. Res. (1991), 37: 487-493; and Houghton et al., Nature (1991), 354: 84-88); peptoids (Internation Publication No. WO 91/9735); encoded peptides (International Publication No. WO 92/00091); benzodiazepines (U.S. Pat. No. 5,288,514); diversomers such as hydantoins, benzodiazepines, and dipeptides (Hobbs et al., Proc. Nat. Acad. Sci. USA (1993), 90: 6909-6913); vinylogous polypeptides (Hagihara et al., J. Amer. Chem. Soc. (1992), 114: 6568); Chen et al., J. Amer. Chem. Soc. (1994), 116: 2661; oligocarbamates (Ho et al., Science (1993), 261: 1303); and peptidyl phosphonates (Campbell et al., J. Org. Chem. (1994), 59; 658). In some embodiments, small organomolecules are selected from libraries that contain diverse and drug-like compounds. See, e.g., Golebiowski et al., Curr. Opin. Chem. Biol. (2001), 5, 273-284; Walters et al., Curr. Opin. Chem. Biol. (1999), 3, 384-387; and Gordon et al., Combinatorial Chemistry and Molecular Diversity in Drug Discovery, 1998, Wiley-Liss, Inc.

In other embodiments, to enhance the probability of finding potent hits (compounds with high affinity for the target) or lead molecules, natural product-based libraries may also be tapped for samples to provide additional diversity and biological relevance to combinatorial libraries. See, e.g.: Gordon et al., J. Med. Chem., (1994), 37: 1385; U.S. Pat. No. 5,539,083 (nucleic acid libraries, peptide nucleic acid libraries); Liang et al., Science (1996), 274: 1520-1522 (antibody libraries); and U.S. Pat. No. 5,593,853. For additional libraries of small organic molecules, see, e.g.: Baum, C&EN (Jan. 18, 1993), 33 (benzodiazepines); U.S. Pat. No. 5,569,588 (isoprenoids); U.S. Pat. No. 5,549,974 (thiazolidinones and metathiazanones); U.S. Pat. Nos. 5,525,735 (pyrrolidines) and 5,519,134 (morpholinos); U.S. Pat. No. 5,506,337; and U.S. Pat. No. 5,288,514 (benzodiazepines).

Using such libraries, thousands of molecules can be screened for binding to a protein target in high throughput fashion. Such combinatorial chemical libraries can then be screened in one or more assays to identify those library members that display a desired characteristic activity. The compounds thus identified can serve as conventional “lead compounds” or can themselves be used as potential or actual protein markers or therapeutics.

Secondary Assays

After determining high binding organomolecules, one or more secondary assays may be performed to further characterize organomolecules. For example, the organomolecules may be further characterized by forming the protein/small organomolecule complex at increased doses of the small organomolecule followed by purification as described above, subsequent dissociation, and quantification by HPLC to identify the binding constant. Additional characterization can be done by functional secondary assays such as cellular assays.

Other exemplary secondary assays include enzyme-linked immunoassay (ELISA), specificity assays (e.g., screening the small organomolecule in a binding assay against another target protein), and cell-based assays that quantify cellular activity.

Structure-Activity Relationship Studies and Optimization of RSPs

After characterization, lead RSP molecules identified from the screening assays may be selected for structural optimization to yield desired binding affinities using, for example, by using high-throughput parallel synthesis (HT-PS) in conjunction with SAR analysis. In some embodiments, focused libraries around lead RSPs are constructed of scaffolds, derived from lead RSPs and combined with an array of monomer inputs. A scaffold is a chemical intermediate or building block having at least one functional handle. If the scaffold has more than one functional handle, the scaffold is orthogonally protected to allow a predictable outcome for the subsequent chemical reactions. Each functional handle may in turn be reacted with a monomer derived from pre-filtered lists from the available chemical directory (ACD) to give the desired molecules. A monomer list includes, for example, primary amines, carboxylic acids, carboxaldehydes, alkyl halides, and the like. The ACD will be pre-filtered to remove molecules having a molecular weight (m.w.) less than 300, inappropriate functionalities (e.g., heavy metals, polycyclic aromatics, polyene systems), and interactive functional groups that could alter the course of the chemical reaction. Where such functional groups are available in protected form, they may be included and the minimum m.w. threshold applied to the unprotected species. All compounds in the ACD are characterized, preferably using HPLC/MS. Preferably, at least 10% of the ACD species are also checked by NMR spectroscopy to ensure the correct structural identity obtained using HPLC/MS and a minimum of 85% purity. In a preferred embodiment, all the compounds of the ACD synthesized are screened in the inventive assay and the SAR results are studied to optimize the structure of one or more lead RSPs as typically done in drug-discovery.

When the inventive screening assay is used to discover compounds for potential therapeutic applications, SAR analysis may also be employed to optimize the ADME (absorption, distribution, metabolism, and excretion), PK (pharmacokinetic), and physicochemical properties of lead RSP structures to enhance the likelihood for successful development as a drug. Complementary techniques often employed in iterative approaches to drug design, such as the use of computational chemistry models to predict properties such as solubility, metabolism, or permeability, may also be used to optimize the structure of the RSP.

Binding Reactions and Separation of Protein:Complex

The general format and conditions of the binding reaction are similar to those used, e.g., for conventional high-throughput drug screening paradigms or known diagnostic assays that use a ligand-binding assay with a labeled tracer molecule, e.g., radiolabeled, fluorescent-labeled ligands, or mass spectroscopy.

The protein:ligand complex may be micropurified using a suitable separation technique, based on an affinity or chromatographic property of the protein itself or the membrane or liposome environment in which the protein resides. For example, the protein:ligand complex is exposed to a solid support containing an affinity matrix and the unbound material is washed away. In other embodiments, the protein-RSP complex may be directly detected in the binding reaction. In some embodiments, the ligand is extracted from the protein: ligand complex prior to being detected.

Raman Signature Probes Detection

Conventional detection methodologies rely on modifying the marker molecules with readily detectable entities like radioactive or fluorescence tags. There are significant limitations associated with these tagging methods, particularly if the desirable biomarker is a small drug-like molecule. The sheer bulk or limited chemistry attributed to many of these tags restricts the types of biomarkers that can be considered.

The present invention takes advantage of the unique spectroscopic signature associated with unique chemical functional groups, including, but not limited to, cyano-group, acetynyl group and deuterium label with a sensitive forms of spectroscopic detection known as Coherent Anti-stokes Raman Spectroscopy (CARS), Surface Enhanced Raman Spectroscopy (SERS), and Surface Enhanced Resonance Raman Spectroscopy (SERRS). In some embodiments, the unique chemical functional groups do not naturally exist in biological specimens, thus enabling the use CARS, SERS, or SERRS to detect the RSPs that are specifically bound to target proteins both biochemically and histologically.

Just as contrast agents are used in Radiology to image anatomical detail, RSPs can be used analogously to visualize the location of a drug target protein at the cellular level. To detect RSPs, a system, e.g. one built based on the CARS technology, will specifically detect the spectral region characteristic of the unique chemical functional group. CARS relies on the fundamental vibrational properties associated with chemical bonds. When stimulated with the appropriate wavelength of light, a given chemical bond will absorb or scatter the incident light with a specific characteristic that is specific to that bond. These absorption and scattering properties can be measured and therefore used to identify and characterize the molecular constituents in a particular sample. CARS is able to detect the characteristic scattering of light that occurs when a particular wavelength of light encounters a biological sample, a phenomenon known as Raman scattering. In CARS, Raman scattering is generated using two laser light sources, which allows for a greater than 1000-fold amplification of the Raman signal, thereby making it feasible to detect RSPs within the complex chemical makeup of a biological sample. The CARS technique has been used previously to examine the general molecular vibration spectra of biological samples in an experimental microscopic imaging system. As it was applied, the experimental system was able to successfully image the general lipid and phosphate distribution within a cultured cell but it has not been used to detect specific spectroscopic signatures of small molecular compounds in biological specimens. The present invention contemplates, for example, a microscope-based imaging system that will detect for example RSPs in histological samples prepared from animals treated systemically with the biomarkers.

Binding Reactions and Separation of Protein:Complex

The general format and conditions of the binding reaction are similar to those used, e.g., in conventional high-throughput drug screening paradigms or known diagnostic assays that utilize labeled tracer molecules, e.g., radiolabeled, fluorescent-labeled ligands, or mass spectroscopy.

In some embodiments, the protein:ligand complex is micropurified using a suitable separation technique, based on an affinity or chromatographic property of the protein itself or the membrane or liposome environment in which the protein resides. The protein:ligand complex is exposed to a solid support containing an affinity matrix and the unbound material is washed away.

In other embodiments, the protein:RSP complex is detected within a complex mixture, e.g., without performing a separation step.

Raman Signature Probes

Raman spectroscopy is based upon Raman effect, which may be described as the scattering of light from a gas, liquid, or solid with a shift in wavelength from that of the usually monochromatic incident radiation. Central to aspects of the inventive RSP technology is that the Raman spectrum of the particular compound depends on the vibrational properties of its specific chemical bonds and is thus molecularly specific. These ligand probes, which include small organomolecule probes, bind specifically and with high affinity to the target biomolecules and do not require an adjunct label, such as a fluorophore, for detection. The potential for using RSPs in sensitive, real-time analyses is becoming realized through recent advances that have been made in the field of Raman spectroscopy and in particular in Surface Enhanced Raman Scattering (SERS) using gold surface or silver surfaces to enhance Raman signals. SERS has been applied in several applications for detection of biological and chemical agents such as the detection of bacterial spores (Grow et al., J. Microbiol. Methods 53 (2003) 221-233), amphetamine (Faulds et al., Analyst 127 (2002) 282-6), and amino acids (O'Neal et al., J. Biomed. Opt. 8 (2003) 33-39).

The inventive RSP technology identifies Raman-active chemical bonds that are either already present in or are incorporated into small molecules and uses these RSPs as specific markers to track the compounds. The resultant RSP tags are then used as effective probes for tracking biomolecules spatially and quantitatively using Raman spectroscopy. These distinctive Raman-active bonds have characteristic signature frequencies that are detectable within the background of the Raman signal contributed by the biological sample.

Furthermore, just as combinatorial chemistry has demonstrated the power of being able to manipulate chemical diversity to develop highly specific small molecules as therapeutic drugs, the present invention contemplates the use of a “combinatorial approach” to develop highly specific RSPs for a variety of biological targets.

The versatility of RSPs coupled with Raman detections, e.g., SERS detection, offers the following advantages. For example, in some embodiments, the RSPs are small chemical compounds. This enables an organic chemist to exploit the tremendous structural diversity of small chemical compounds, to identify and optimize RSPs for use in the detection of various agents, including bioterrorism or biowarfare. In one embodiment of the invention, the RSPs are designed to specifically bind to single target with high affinity yet be diverse enough to selectively recognize several members of a protein family. In another embodiment several RSPs can be used in cocktail fashion to detect several targets simultaneously, for example, in blood sample containing a toxin or toxins such as Botulinum A, B and F (Schmidt J. J. etal, Applied and Environmental Microbiology, 69, 297, 2003), three RSPs can be added to the contaminated blood sample, wherein each RSP specifically recognizes one of the toxins. This allows for the determination as to which, if any, of the three toxins are present in the sample without having to perform three separate tests.. In other embodiments, the RSPs can have multiplexing capability to detect several targets within a single sample. In still other embodiments, the RSPs are customized for desired properties, for example crossing the bacterial cell wall. In yet other embodiments the RSPs are stable and readily reproduced in large amounts.

RSPs made by converting a ligand, such as a protein, peptide, nucleotide, oligonucleotide, or antibody, into the RSP by modifying the ligand to include a cyano, nitro, alkynyl, deuterium, or halogen group are also provided herein. RSPs that allow for real-time detection are provided herein. In some embodiments, the sensitivity of the RSP is in the femtomolar range. In other embodiments, the sensitivity of the RSP is in the nanomolar range. In still other embodiments, the sensitivity of the RSP is in the micromolar range.

Halogenated RSPs

If the RSPs identified in the binding assay contain one or more halogen atoms (F, Cl, Br, I), e.g., bonded to carbon, they may be used as halo-RSPs. In some embodiments, the RSPs are halogenated with chlorine or fluorine. In other embodiments, the halo-RSPs are F-RSPs. Since molecules containing carbon-fluorine bonds rarely exist in natural products (see Key et al., Environmental Science and Technology (1997), 31: 2445-2454), however, it may be necessary to derivatize a lead RSP structure to introduce a fluorine atom or C—F bond to yield an F-RSP, which can be advantageously used as an imaging or mapping reagent.

Fluorine imparts oxidative and thermal stability because a C—F bond is stronger than a C—H bond and generally cannot be modified biologically. Consequently, RSPs having a C—F bond are especially useful as markers for in vitro imaging using an appropriate optical method such as CARS.

RSP molecules that are confirmed to have high binding affinities are subjected to fluorine-structure activity relationship (F-SAR) derivitization if no fluorine atom or fluorine-carbon bond (C—F) is present in the RSP molecules. In one embodiment, at least one carbon-hydrogen bond in an RSP is converted to a carbon-fluorine bond. Depending on the chemical structure and biological system, one or multiple C—F bond may be needed. Because fluorine is the second smallest substituent and closely mimics hydrogen, any C—F change should not affect the steric requirement at the receptor site. In another embodiment, a trifluoromethyl group is used to improve pharmacological activity, such as through enhancement of rates of absorption and transport of the resulting compound in vivo. Alternatively, a fluorine atom may be introduced through addition of a suitable substituent containing a fluorine atom. In one embodiment, a fluorine atom is introduced into different positions of the RSP structure to allow the identification of an optimal F-RSP molecule.

The chemical synthesis of halo-RSPs can be achieved using a suitable reaction scheme, which could range from a one-step reaction to a several-step reaction depending on the complexity of the structure of the RSP to be fluorinated. For example, if a Cl-RSP is to be synthesized, a suitable chlorine-containing reagent may be used following chlorine chemistry techniques generally known in the art. In various embodiments for preparing F-RSPS, one of the steps is a fluorination reaction, which preferably employs an appropriate fluorine-containing reagent, such as a reagent shown in Table 1 below.

TABLE 1
Exemplary Fluorinating Reagents

| | |
|---|---|
| 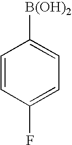 | 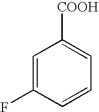 |
| 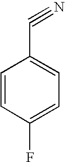 | 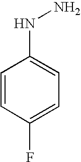 |
| 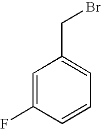 | 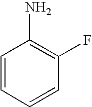 |
| 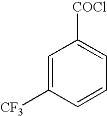 | 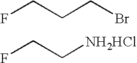 |

After synthesis of the halo-RSP, it is characterized and screened in the binding assay as described herein.

Acetylyl RSPs, Cyano RSPs or Nitro-Containing RSPs

If any of the RSPs identified in the binding assay contain one or more acetynyl, cyano or nitro groups, they may be used as acetynyl-containing RSPs, cyano-containing RSPs or nitro-containing RSPs.

Since molecules containing acetynyl, cyano or nitro groups do not exist in biological systems, they can be advantageously used as an imaging or mapping reagent. Acetynyl, cyano and nitro groups have been used as substituents in drugs (e.g. Zaleplon, a hypnotic drug, and Loprinone hydrochloride, a cardiostimulent) and each have strong distinct bands in the Raman spectrum (Bernhard Schrader, infrared and Raman Spectroscopy, VCH publishers, New York, 1995). Furthermore, these bands, and in particular those bands corresponding to the cyano and acetynyl groups, are in a region where there is minimal or no interference with bands from biological systems thereby making them easy to detect.

RSP molecules that are confirmed to have high binding affinities can be modified to acetynyl-containing, cyano-containing or nitro-containing molecules if no acetynyl, cyano or nitro group is present in the RSP molecule. Cyano, acetynyl or nitro groups may be introduced through a variety of methods known in the art, such as, the use of a suitable reagent containing an acetynyl, cyano or nitro group. In one embodiment, a cyano, acetynyl, or nitro group is introduced onto different positions of the RSP structure to allow the identification of an optimal acetynyl-, cyano- or nitro-containing RSP molecule. In another embodiment, the optimal acetynyl, cyano or nitro group is placed on an aryl or heteroaryl group of the organomolecule.

The chemical synthesis of acetynyl-containing RSP molecules, cyano-containing RSP molecules or nitro-containing RSP molecules can be achieved using a suitable reaction scheme, which could range from a one-step reaction to a several-step reaction depending on the complexity of the structure of the RSP to be changed to a cyano-containing RSP, acetynyl-containing RSP or a nitro-containing RSP. For example, if a cyano-containing RSP, acetynyl-containing RSP or nitro-containing RSP is to be synthesized, a suitable cyano-containing, acetynyl-containing, or nitro-containing reagent may be used to introduce the cyano group, acetynyl or nitro group onto the RSP. General chemistry techniques known in the art would allow one to choose an appropriate reagent and technique depending on the structure of the RSP. For example, the cyanation, acetynylation, or nitration of aromatic rings is described in Advanced Organic Chemistry, John Wiley & Sons, New York, 1992. Exemplary reagents used in preparing cyano-containing RSPs or nitro-containing RSPs are shown in Table 2 below.

TABLE 2
Exemplary Cyano-, Acetynyl-, and Nitro-Containing Reagents

| | |
|---|---|
| 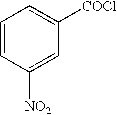 | 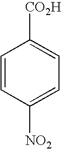 |
| 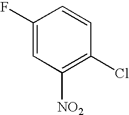 | 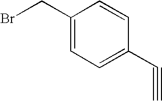 |
| 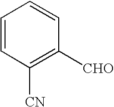 | 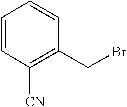 |
| 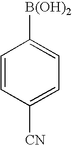 | 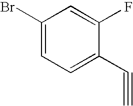 |

After synthesis of the cyano-containing RSP, the acetynyl-containing RSP or the nitro-containing RSP, it is characterized and screened in the binding assay as described herein.

Deuterated RSPs

There are various advantages to labeling an RSP with deuterium. For example, since deuterium is a non-radioactive isotope of hydrogen having chemical properties that are virtually identical to the normal isotope, replacement of one or more hydrogen with deuterium will have minimal, if any, impact on the biological activity of the compound. Additionally, substituting a deuterium for a hydrogen will lower the vibrational frequency by a factor of about 1.414, placing it into a range typically devoid of other spectroscopic features. This dramatic shift, about 800 to 900 cm⁻¹ for C—H bonds and about 900-1000 cm⁻¹ for O—H bonds, coupled with the fact that there are inherently very few other Raman or Infrared features in the same spectral regions, is particularly advantageous.

RSP molecules that are confirmed to have high binding affinities are modified to deuterium containing RSPs. Deuterium may be introduced through a variety of methods known in the art, such as the use of suitable reagent containing deuterium. In many cases, the chemist of ordinary skill in the art will be able to introduce the deuterium at one or more stages during the synthesis of the chemical compound by replacing the reagent used in the original synthesis with one or more reagents comprising deuterium in place of hydrogen. In another embodiment, deuterium may be introduced into the compound by deuterium-hydrogen exchange in the presence of D₂O.

Other Exemplary Small Organomolecule RSPs

Small organomolecule RSPs that bind to a biological target or recognizes a function of biological target and can be used to determine the location, function, and/or quantity of the biological target using Raman spectroscopy. Examples of small organomolecules and their biological targets are provided below:

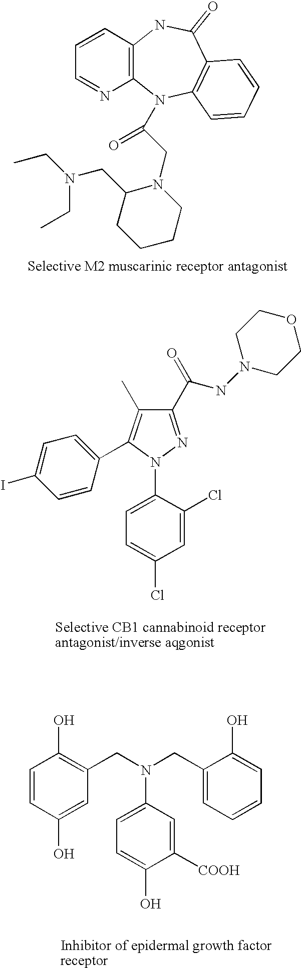

In some cases, ligands that do not contain one or more cyano, halogen, acetynyl, nitro, or C-D group, are used as RSPs. In these embodiments, the ligands, e.g., small organomolecules, contain unique chemical functional groups that can be distinguished from the background. The chemical functional group that will be detected will depend on various factors such as the ligand, the solvents, and any un-removed milieu present in the sample. Other exemplary unique chemical functional groups that could be used in the RSP technology described herein are summarized in table 3 below.

TABLE 3

| | | Exemplary |
|---|---|---|
| Chemical | | Raman |
| Functional | | Region |
| Group | Type of group | (cm⁻¹) |
| C═O | Esters, Ketones, amides, carboxylic acids | 1870-1550 |
| | and their salts, acid anhydrides | |
| C═C | Olefinic compounds | 1690-1620 |
| | Aromatic ring systems | 1600-1450 |
| S═O | Sulphoxides, Sulphates, Sulphites, Sulphinic | 1420-990 |
| | acids or esters, Sulphones, Sulphonic acids, | |
| | Sulphonates, Sulphonamides | |
| C—O—C | Ethers (aromatic, olefinic or aliphatic) | 1310-1020 |
| C═S | Thioesters, Thioureas, Thioamides pyrothiones | 1225-1045 |

Detection of RSPs

The identification of compounds useful for mapping or imaging receptor activity provides RSPs which may be used to validate drug targets and identify or characterize the mechanism of action of existing drugs. The unique spectroscopic spectra attributed to the specific chemical functional group, e.g., carbon-halogen bonds, acetynyl groups, C-D bonds, cyano groups, or nitro groups is used to detect the RSPs in tissues and fluids using techniques such as laser Raman spectroscopy, coherent anti-Stokes Raman scattering (CARS) or Infrared spectroscopy.

An apparatus for detecting carbon-halogen bonds using laser Raman spectroscopy is described in U.S. Pat. No. 6,307,625 to Sharts et al. An apparatus for performing nonlinear vibrational microscopy using coherent anti-Stokes Raman scattering or sum frequency generation is described in U.S. Pat. No. 6,108,081 to Holtom et al.

Generally, CARS employs a low-power continuous wave (cw) pump laser beam and a low-power cw anti-Stokes (probe) laser beam that simultaneously illuminate the biological material in a co-linear fashion. The pump beam frequency is capable of being varied and is used to induce Raman emission from the biological material. The probe beam frequency is held constant and the intensity is monitored as it leaves the biological material. At the point that the frequency difference between the pump and the probe beam equals a Raman vibration mode frequency of the biological material, the weak probe signal becomes amplified by one or more orders of magnitude due to the Raman emission from the pump beam. When the frequency difference between the pump and probe beam is within the resonant Raman spectrum for a given chemical group such as a carbon-halogen bond (e.g., CF₃: 1350-1120 cm⁻¹ or C6H₅F: 1230 cm⁻¹), acetynyl group (e.g., 2250-2100 cm⁻¹) cyano group (e.g., 2255-2220 cm⁻¹), C-D bond (e.g., 2200 cm⁻¹), or nitro group (e.g., 1380-1340 cm⁻¹) a CARS signal is generated and is detected by monitoring the change in intensity of the probe beam. From this signal, a differential contrast image of where the RSP is in the sample can be obtained by scanning the sample in a faster fashion.

In some embodiments, the halogen introduced into the RSP structure is fluorine. Because molecules containing carbon-fluorine bonds do not naturally exist in biological specimens, it is possible using a technique such as CARS to detect fluorine-tagged RSPs that are specifically bound to target proteins both biochemically and histologically. The use of F-RSPs as biomarkers offers various advantages. For example, the modification of small molecules with fluorine, a small chemical entity, typically has minimal or no detrimental impact on a compound's activity and sometimes even enhances the binding annuity or pharmacological properties of the compound. Furthermore, since the C—F bond is stronger than the C—H bond, the fluorinated compound is more stable and less likely to be actively degraded or removed from a biological system.

Analogous to contrast agents used in radiology to image anantomical detail, RSPs may be used to visualize the location and activation state of a drug target protein at the cellular level. In some embodiments, RSPs are detected in histological samples prepared from animals treated systemically with the biomarkers. In some embodiments, the RSP is administered in vivo to an animal, preferably a mammal (e.g., a human, monkey, dog, rabbit, or mouse), or administered in vitro to a biological specimen from such an animal (e.g., incubation of a tissue specimen), and a biological sample (e.g., tissue, blood, serum) is obtained for analysis. For administration, any suitable technique may be employed, such as those described in International Publication No. WO 01/02865. A detection technique such as CARS is used to analyze the sample. Thus, RSPs may be used in a variety of applications, such as to validate drug targets, determine the mechanism of action of drugs, to diagnose disease states (as an in vitro or in vivo diagnostic), or to evaluate the efficacy of a treatment.

Resonance Raman Spectroscopy (RRS) and Surface-Enhanced Raman Spectroscopy (SERS) may also be used for mapping and imaging. See, e.g., Schrader, B et al., Infrared and Raman Spectroscopy (ed. VCH, Weinheim, Germany 1995). Furthermore, depending on the RSP, it may not be necessary to modify the compound to form a halogen-containing RSP, acetynyl-containing RSP, cyano-containing RSP, nitro-containing RSP, or deuterated-containing RSP before using one or more of these mapping/imaging techniques.

For the sake of brevity, all patents and other references cited herein are incorporated by reference in their entirety as if they appear in full within this document.

### EXAMPLES

The invention has been described in an illustrative manner, and it is to be understood that the terminology used is intended to be in the nature of description rather than of limitation. The present invention is further illustrated by the following examples, which should not be construed as limiting in anyway. The experimental procedures to generate the data shown are discussed in more detail below.

### Example 1

### Serotonin Transport Analysis Using CARS

RSP Design

The serotonin transport system is one of the pharmaceutical industry's most successful therapeutic targets and consequently there is a great deal of information regarding the pharmacology of manipulating its function. As a result, there are also a large number of high affinity small molecule tools available that target this family of monoamine transporters. These tools will serve as a basis for developing small molecule probes that can be used to image transport function. Many of these small molecule tools are known to act as substrates for the transporter which can be taken up by the transporter and concentrated intracellularly. Using recombinant and native cells expressing the serotonin transporter, small molecules that are known to act as substrates will be used as leads for developing RSPs. Focusing on these in vitro model systems will provide the best opportunity for optimizing the CARS technology necessary for detecting and imaging small molecule probes within a biological environment

MCPP is a known SERT substrate and will be selected as lead because of its high potency for 5-HT and, because its modification would be amenable to high throughput parallel synthesis.

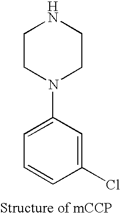

The substituents that will be part of the SAR campaign are cyano-, acetylenic and nitro-groups, C—Halogen bonds (C—F, C—Cl, C—Br, C—I), and C-D bond. These bands have different Raman shifts and each one exhibits a range of frequencies depending on their environment within the molecule (Schrader, B., Infrared and Raman Spectroscopy, ed. VCH Weinheim, Germany, 1995).

Replacement of hydrogen with deuterium, a non-radioactive isotope of hydrogen that is virtually identical with the normal isotope with regard to chemical properties, will not impact the biological activity of a particular molecule. In addition, C-D bond wavelength is within a region where there is no interference with the background associated with the biological system. Cyano- and acetylenic groups wavelengths are also outside of the ones corresponding to biological background. These facts make C-D bond and, cyano- and acetylenic groups ideal bands for imaging of small molecules within the biological systems. However, there are some issues associated with these bands such as, stability of C-D bonds under certain chemistry conditions and the inherent chemical properties of cyano- and acetylenic groups that might negatively impact the biological activity. When these issues arise, the other bands can be used to find the optimized RSPs. Their wavelength ranges will allows the tuning of the molecule by chemical modification to generate a molecule probes with a frequencies outside of the one corresponding to biological systems. For instance, a fluorine atom or group containing fluorine, such as trifluoromethyl, may be introduced into different positions of mCPP phenyl ring to allow the identification of optimal molecule probe

The first step in the process of developing such probes consists of performing a SAR study around mCPP using groups and bonds described above. mCPP contains already a chloro-substituent and, as a consequence, it can be used as a RSP. However, to generate the optimized RSP, it is necessary to explore the other bands in different positions of the molecule. To achieve this, combinatorial libraries will be developed around this lead where the aromatic ring will be modified to contain at least one cyan-group or deuterium or acetylenic group or nitro-group and or C-halogen bond, and the basic amine can be substituted with small alkyl groups, such as methyl and ethyl groups. The aromatic ring will be changed also to other phenyl isosters such as pyridine and pyrimidine, these changes might impact the electronic distribution of the molecule and, as a consequence, they might lead to different Raman shifts compared to their phenyl analogs.

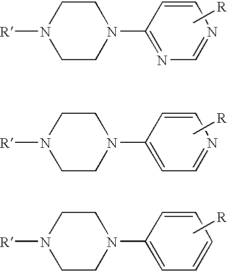

Scheme 1 outlines an example of synthetic route to potential RSPs. Piperazine (1) can be coupled with aryl halides (2) using palladium-catalyzed amination (Beller, M., Breindl, C., Riermeier, T. H. and Tillack, A. J. Org. Chem. 66: 1403-1412, 2001). When the aryl group contains more than one halogen, aryl triflates (3) can be used in the palladium-catalyzed amination to avoid the coupling of more than one piperazine.

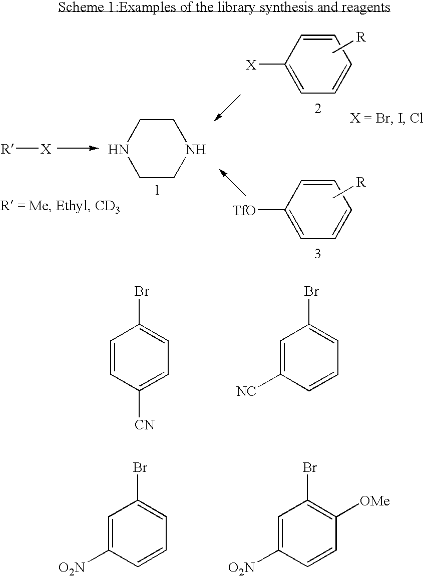

Prior to subjecting potential RSP compounds to image analysis, their relative ability to inhibit the serotonin transporter will have to be compared to the parent compounds in radiolabeled uptake assays. This is readily preformed in cell lines expressing the human serotonin transporter (HSERT) and standard uptake protocols using 5-hydroxy[3H]tryptamine ([3H] 5-HT) as the radiolabeled tracer (Rothman, R. B. and Baumann, M. H. Pharmacol Ther 95: 73-88, 2002, Ramamoorthy, S., Melikian, H. E., Qian, Y., Blakely, R. D. Methods Enyzinol 296: 347-70, 1998). Uptake assays will not only be used to evaluate the pharmacological profile of the RSP compounds but will also be used to determine if they act as substrates for the transporter. Because transported molecules are concentrated intracellularly, substrate probes will enhance our ability to detect and visualize them.

Radiolabeled Assay

Serotonin transport assays are performed according to the general method described by Ramamoorthy, et al., '98. All experiments are carried out at room temperature (˜22° C.) unless otherwise indicated. Transporter expressing cell lines are plated on poly-D-lysine (PDL) coated tissue culture dishes at ˜4×104 cells/cm² at least 24 to 72 h prior to performing the uptake assay. The growth media is removed by aspiration and the cells are preincubated for 10 min with Krebs-Ringer-HEPES (KRH (in mM): 130 NaCl, 1.3 KCl, 2.2 CaCl₂, 1.2 MgSO₄, 1.2 KH₂PO₄, 10 HEPES, and 1.8 g/liter glucose, pH 7.4) medium with or without 1 μM Paroxetine. Paroxetine, a specific SERT blocker, is used to establish non-specific transport activity in cells. Transport is initiated by the addition of [3H]5-HT (˜100 Ci/mmol; Amersham, Arlington Heights, Ill.) and terminated by three rapid washes with KRH containing 1 mM imipramine. Accumulated [3H]5-HT is determined by liquid scintillation of 1% (w/v) SDS-solublized cells.

To evaluate the substrate properties of the compounds, transport assays are performed on cells preloaded with [3H]5-HT and the efflux is assessed in the presence of the candidate substrate molecules. Cells are loaded by performing transport as described above. After a 20 min incubation with [3H]5-HT, cells are quickly washed twice in KRH without imipramine. The test compounds are then added for analysis. To assess the basal accumulation and leakage of [3H]5-HT, control samples containing either 1 mM imipramine or buffer alone are compared to the amount of [3H]5-HT released in the presence of candidate substrate compounds.

RSP CARS Signal Analysis

RSP molecules that are substrates for SERT are next characterized for the quality of their Raman signal relative to the biological background by sampling the specific CARS Raman wavenumber attributed to the RSP of interest from hSERT-HEK cells incubated with the compound for transport. Although the CARS microscope is used for this analysis, multidimensional information that is normally required for creating an image is not necessary, and the hardware is only used to acquire a one dimensional spectroscopic profile of the compound within a biological environment. This type of information is acquired across larger field areas than what are typically used for high resolution imaging and allows for this analysis to be done quickly. This approach is also amenable to analysis in multi-well formats so that a relatively large number of compounds can be characterized for their specific CARS signature.

Molecular Imaging using RSPs

Those compounds that show the most robust signal to background are used for imaging analysis. Although recombinant cells expressing SERT will accumulate substrates that can be detected either through the use of radiolabeled or fluorescent tracers. In order to facilitate the imaging of RSPs, the rat basophilic leukemia (RBL-1) cells will be used in the initial imaging studies (See ‘General Methods’ Section D.5). RBL-1 cells are known to express both the plasma membrane SERT as well as the vesicular monoamine transporter (VMAT), which transports and concentrates catecholamines into intracellular vesicles. The concentration of RSPs into these vesicles offers the best opportunity for optimizing the conditions for detecting and imaging RSPs by providing a high signal density in a small localized area in the cell.

Although CARS is capable of acquiring images form viable cell preparations, the imaging of transported RSPs will initially be performed on fixed cells. Cells will first be exposed to the RSP substrate under standard transport assay conditions and then fixed in the presence of the irreversible, non-transportable inhibitor, imipramine. Fixed preparations allow for optimization of the necessary imaging conditions in a static cellular environment. Once the conditions are optimized for detecting the RSP in the RBL-1 vesicles, experiments will be conducted in real time. This capability will provide a novel opportunity to visualize the kinetics and distribution of transported substrate molecules under different physiological conditions.

CARS Detection

Transport assays in which, the accumulation of RSPs is detected by CARS, are performed similarly to what is described for the radiolabeled assays with the following modifications. For spectroscopic characterization of RSP candidates, cells are plated on PDL coated 24-well dishes and following termination of the transport assay the cells are stored in KRH containing 1 mM imipramine and 1% thimerosol prior to analysis.

For imaging, cells are plated on PDL coated multi-well chamber Permanox slides (Nunc). Following termination of the transport assay, the cells are fixed in freshly prepared 4% paraformaldehyde in KRH, for 10 min at 4° C. and mounted with coverslips using a 50% (v/v) glycerol:KRH solution containing 0.1% sodium azide. RSPs may also be detected on live cell preparations in real time. For those experiments, the background signal is first established by washing the cells in KRH and acquiring an initial CARS image in the absence of the RSP. The RSP is then added and images are acquired over time.

### Example 2

### Bacteria Detection Using SERS

Biomolecule Target Selection—FabI

Antibiotics work through many different mechanisms but they all rely on targeting biochemical mechanisms that are unique to their microbial targets. The fatty acid biosynthesis pathway in bacteria has been the focus of recent antimicrobial research and several compounds from this work have been developed into successful commercial antibiotics (Heath et al., Appl. Microbiol. Biotechnol. 58 (2002) 695-703). One of the most widely used antibiotics that targets the bacterial fatty acid synthesis pathway is known as Triclosan (Sivaraman et al., Biochemistry 42 (2003) 4406-4413). It is known to inhibit the NADH-dependent enoyl acyl carrier reductase (FabI) the enzyme that catalyzes the final rate-limiting step of fatty acid synthesis in bacteria. Extensive small molecule discovery and development has been done using Triclosan as a lead molecule and FabI as the target. As a result, there are a wide variety of commercially available compounds, such as Compound 1 below, to use as starting points in the development of microbial-directed RSPs. For purposes of this example, Compound 1 is the lead for developing a molecular probe that will detect a variety of bacterial pathogens.

RSP Design and Synthesis

With the objective of taking compound leads and modifying them to generate optimized RSPs we have established the following scheme for achieving this goal:

Compound leads are first chemically modified to incorporate Raman active bonds then tested for their affinity against the target protein in this case the FabI enzyme. Those compounds that maintain high binding affinity will be considered candidate RSPs and will be tested to determine their signal to background within a sample containing bacteria. Compounds with high signal to background ratios that can be readily detected within the background Raman signature contributed by the biological sample will be used in assays for the detection of pathogens.

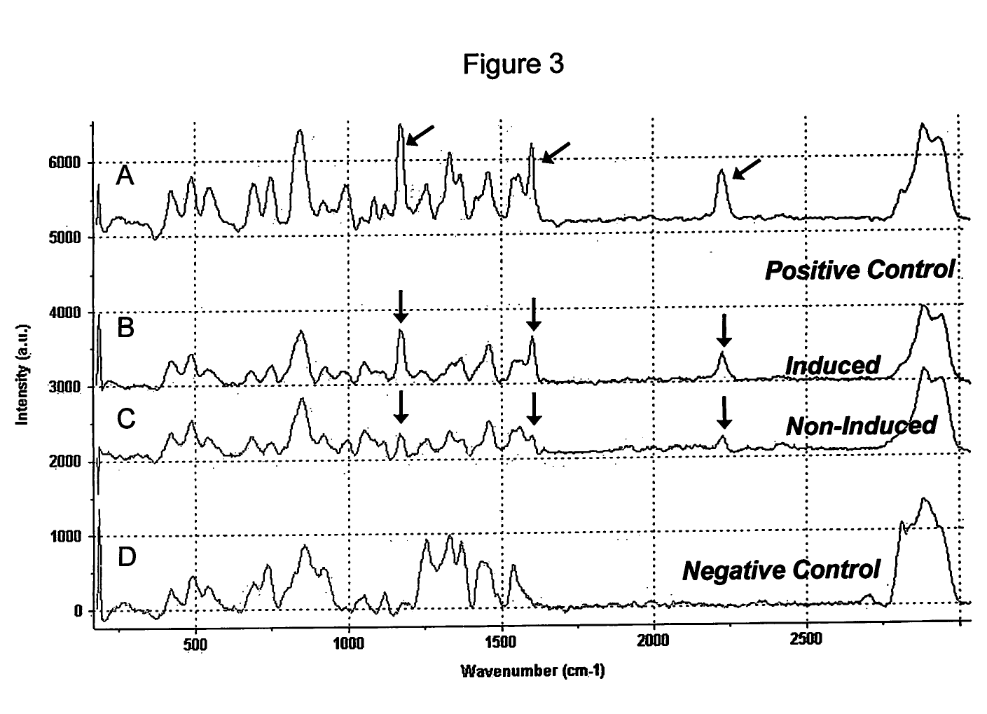

The compound shown in FIG. 3, shown below, has been selected as the lead for the development of RSPs because its modification would be amenable to high throughput parallel synthesis.

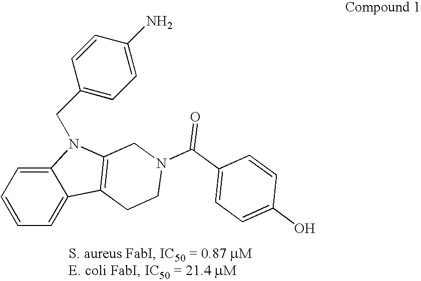

A combinatorial library, shown in FIG. 3 below, was built using commercially available starting materials analogous to those shown below.

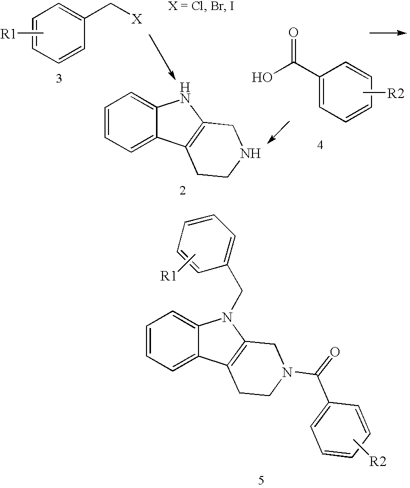

Reagents 3 and 4 were chosen from commercial sources and contained Raman-active bonds (e.g., amide linker, R1 and/or R2) to allow the development of optimized RSPs.

The synthesis of compound 5 was performed in a manner analogous to the procedure outlined below.

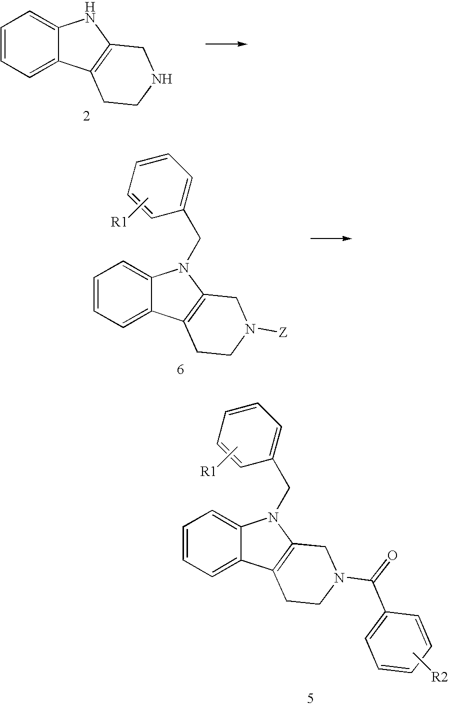

Carboxybenzyloxy (Z) protection of compound 2 followed by N-9 alkylation using sodium hydride and reagent 4 in DMF gave intermediate 6. Cleavage of carboxybenzyloxy (Z) group and subsequent EDC-mediated acylation afforded compound 5.

Determining RSP Affinity

Prior to using the potential RSP compounds as probes to detect bacteria the modified compounds will be tested for their ability to inhibit FabI. As shown with numerous studies that have explored the structure activity relationship of other FabI inhibitor analogs, there is a good correlation between the ability of a compound to inhibit the enzyme and its affinity towards the enzyme (Seefeld et al., Bioorg. Med. Chem. Lett. 11 (2001) 2061-2065). Recombinant bacteria expressing a HIS-tagged FabI protein are available from Dr. Charles Rock at St. Jude Children's Research Hospital in Memphis Tenn. The overexpressed protein is readily purified as a bioactive enzyme using conventional Ni²⁺ chromatographic methods (Heath & Rock, J. Biol. Chem. 270 (1995) 26538-26542). Enzyme assays will be performed as described by Bergler et al. (J. Biol. Chem. 269 (1994) 5493-5496). Briefly, purified HIS-tagged FabI enzyme is added to a reaction containing NADH and an appropriate substrate (e.g. Malonyl CoA or Crotonyl CoA). The reductase activity is assayed by monitoring the decrease in absorbance at 340 nm due to the consumption of NADH. The inhibitory activity of all RSPs will be compared with Compound 1.

The following are examples of RSPs synthesized using the procedure outlined in scheme 1, above, and described in Seefeld et al., Bioorg. Med. Chem. Lett. 11 (2001) 2061-2065.

| | Com- | |
|---|---|---|
| | pound | EC₅₀ |
| Example of RSPs | Number | (μM) |
| 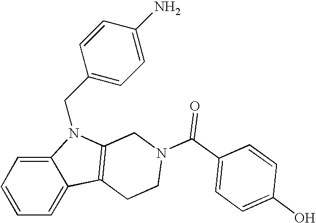 | Com- pound 1 | 0.67 |
| 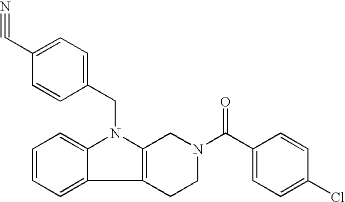 | Com- pound 1A | 2.52 |
| 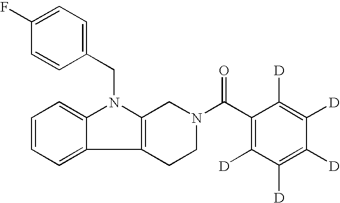 | Com- pound 1B | 1.5 |
| 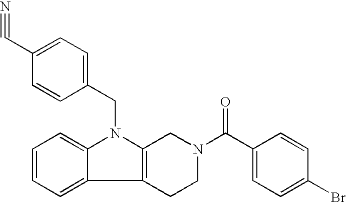 | Com- pound 1C | 2.53 |
| 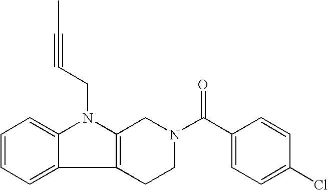 | Com- pound 1D | 6.01 |
| 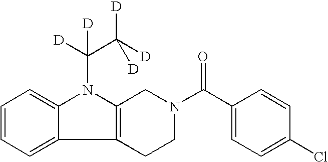 | Com- pound 1E | 7.83 |

Historically, using Raman detection methods in biological assay systems has been limited by the low sensitivity of the technique. However, several recent advancements have significantly enhanced the sensitivity of Raman spectroscopy, including new techniques in surface enhanced Raman scattering, or SERS (Istvan et al., Spectrochim. Acta. A Mol. Biomol. Spectrosc. 59 (2003) 1709-23 and Shrader, ed. Infrared and Raman Spectroscopy, VCH: Weinheim (1995)). SERS enhances the Raman scattering efficiency when molecules are brought in close proximity or absorbed on to metal surfaces that have high surface plasmon resonance cross sections (e.g. Au, Cu, Ag). Through a mechanism that is unclear, this association of molecules with the metal surfaces enhances the Raman signal by factors >10⁸, thus making the sensitivity of SERS comparable with many fluorescent methods. Several methods have been developed for the preparation of the metal nanoparticle films and we will be using films prepared. See, e.g., Gupta et al., J. App. Phys. 92 (2002) 5264-5271.

SERS can also be generated by colloidal gold or silver nanoparticles when molecules are brought in close approximity or absorbed on to the surface of the gold or silver nanoparticles. The size of the nanoparticles can vary between 14 nm to 100 nm and are commercially available from Ted Pella, Inc. and can be prepared as described by Chung-ro Lee etal, Journal of colloid and Interface Science 271, 41-46, 2004. These nanoparticles can also generate SERS when the nanoparticles are coated on paper or glace filters (Wu D etal Journal Colloid Interface Sci, 265, 234-8, 2003).

Once this detection method is optimized the entire assay format can be scaled and made compatible for microarray analysis.

SERS Detection of Compound 1A

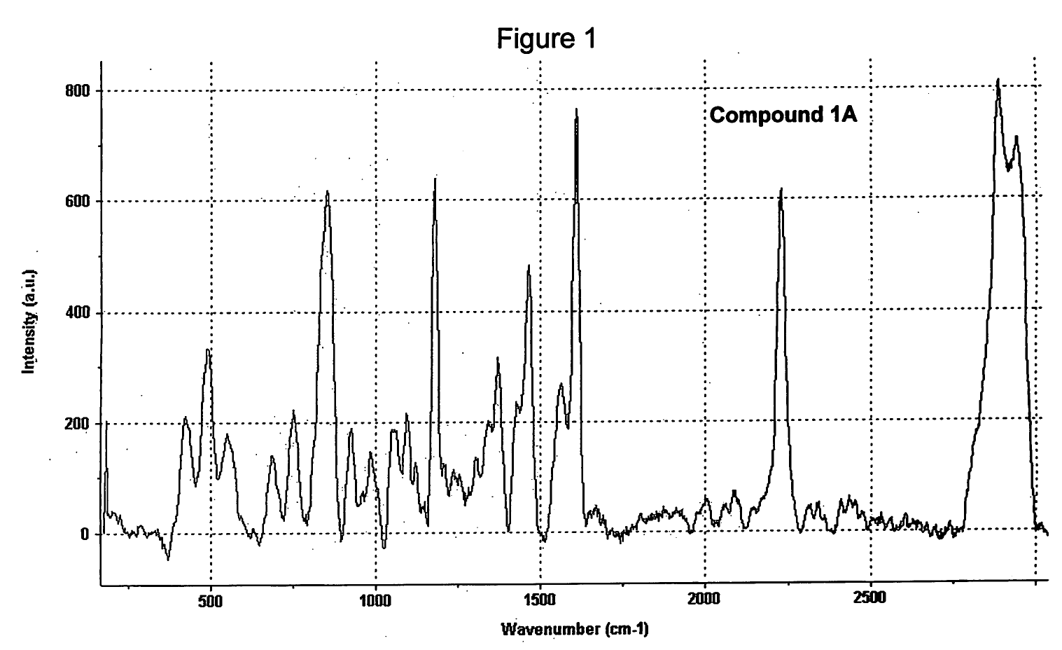

A 10 μM solution of compound 1A (1% DMSO/water solution) was mixed with 20 mn colloidal gold nanoparticles. The mixture was then concentrated using centrifugation and concentrated to about 20 μl. An aliquot of about 3 μl was taken from the sample and analyzed by Raman spectrometer using 632.8 nm laser. FIG. 1 shows the SERS detection of Compound 1A.

SERS Detection of FabI
SERS Detection of Purified Recombinant FabI

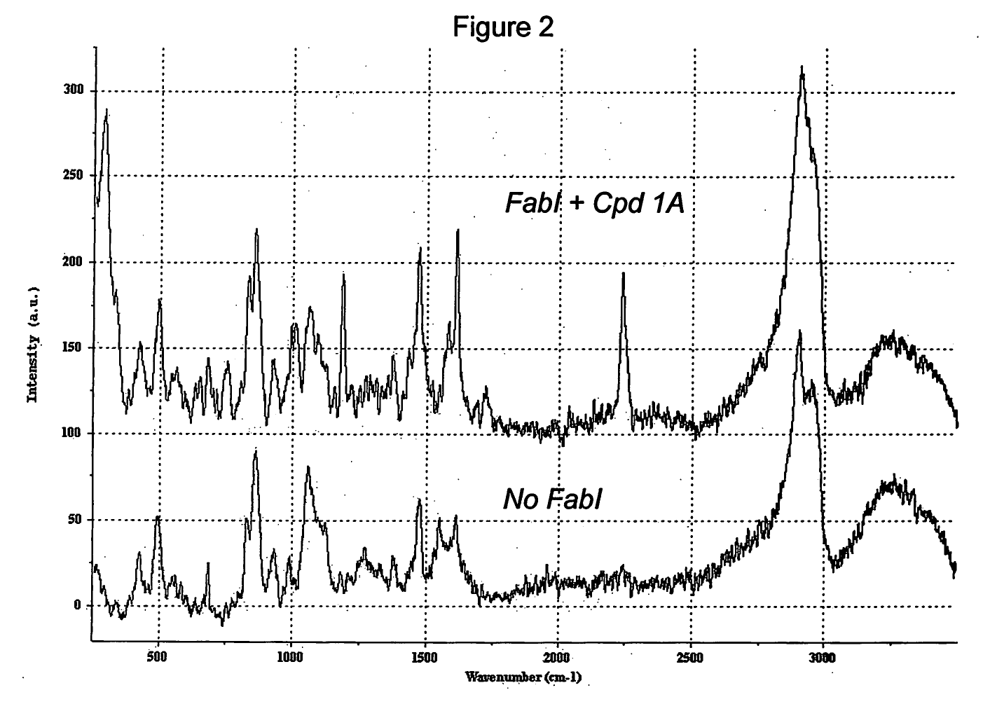

FIG. 2 is an example of SERS detection of compound 1A binding to FabI using gold nanoparticles (20 nm). Recombinant FabI (2 mg/ml) was mixed with compound 1A (10 μM and incubated for 15 minutes at room temperature. Any bound compound was extracted from the protein complex with MeOH and used for SERS analysis. The top spectrum shows several peaks specifically attributed to the presence of compound 1A. The bottom spectrum shows the spectrum obtained if the target protein FabI is removed from the binding reaction.
SERS Detection of Bacteria Expressing FabI

FIG. 3 represents detection of FabI expressing bacteria using compound 1A. Uninduced (C) or isopropyl-beta-thiogalactopyranoside induced (B) bacterial samples expressing recombinant FabI were incubated with the compound 1A RSP as described in the text. Bound compound was recovered from washed bacteria by lysis in chloroform and assayed by SERS using colloidal gold nanoparticles (20 nm). Note the relative increase in PRLX10 specific peaks (arrows) in the induced sample compared to the uninduced sample. (A) is the positive control and depicts the characteristic peaks attributed to the presence of compound 1A (arrows) and (D) is the negative control showing the background signal for these assay parameters.

While the various aspects of the invention have been described in reference to exemplary and preferred embodiments, it should be understood that the invention is defined not by the foregoing detailed description, but by the following claims as properly interpreted.

What is claimed is:

1. A method for detecting a target comprising:
(a) contacting the target with a RSP;
(b) irradiating the RSP with a source of laser light; and
(c) collecting and analyzing a Raman spectra emitted from the RSP;
wherein the RSP is a small organomolecule or a peptide and the small organomolecule or the peptide binds to the target in step (a).

2. The method of claim 1 wherein, the RSP is not complexed to the target in step (b).

3. The method of claim 1 wherein, the RSP is complexed with the target in step (b).

4. The method of claim 1 wherein, the target is used to diagnose a disease.

5. The method of claim 1 wherein, the target is present in an analytical sample obtained from a source selected from the group consisting of water, food, soil, plant material, and air.

6. The method of claim 1, wherein the RSP is a small organomolecule.

7. The method of claim 1, wherein the RSP comprises a chemical functional group selected from cyano, nitro, amide, ester, ether, olefin, sulphoxide, sulphite, sulphinic acid, sulphinic ester, sulphone, sulphonamide, thiol, carboxylic acid, or alkynyl group.

8. The method of claim 1, wherein the RSP is a peptide

9. A method as defined in claim 1, wherein the Raman spectra is selected from CARS, SERRS, or SERS.

10. A method of preparing an RSP, comprising:
(a) selecting a ligand for use as an RSP by a process-comprising:
(i) combining in solution a ligand with a target sample under saturating binding-reaction conditions to yield a mixture containing a target-ligand complex;
(ii) analyzing the target-complex; and
(iii) elucidating the ligand's structure; and
(b) preparing the RSP by:
(i) synthesizing the selected ligand if the structure contains a distinghishable Raman signal; or
(ii) synthesizing analog of the ligand if the ligand does not contain distinguishable Raman signal.

11. A method as defined in claim 10, wherein the ligand is a small organomolecule.

12. A method as defined in claim 10, wherein ligand or the analog of the ligand comprises at least one cyano, nitro, amide, ester, ether, olefin, sulphoxide, sulphite, sulphinic acid, sulphinic ester, sulphone, sulphonamide, thiol, carboxylic acid, or alkynyl group.

13. A method as defined in claim 10, further comprising performing a screening process a plurality of times in a parallel, high-throughput manner with different ligands to select the ligand for use as an RSP.

14. A method as defined in claim 10, wherein mass spectrometry is used to analyze the isolated complex.

15. A method as defined in claim 10, wherein the screening process further comprises purifying the isolated complex prior to the analyzing.

16. A method as defined in claim 10, wherein the target-ligand complex is isolated and then analyzed.

17. A method as defined in claim 10, wherein the elucidating of the ligand's structure is performed before the combining with the target sample.

18. A method as defined in claim 10, wherein the elucidating is performed after the analyzing and comprises locating the ligand in a well of a library plate or array having a plurality of wells each containing a ligand resulting from a combinatorial reaction, and identifying the structure of the expected product of the combinatorial reaction.

19. A method as defined in claim 10, further comprising:
(c) using the RSP as an imaging reagent in a process comprising:
(i) administering the RSP to a subject;
(ii) obtaining a biological sample from the subject; and
(iii) quantitatively detecting for the presence of the RSP in the biological sample.

20. A method as defined in claim 19, wherein the quantitatively detecting is performed using Raman spectroscopy.

21. A method as defined in claim 19, wherein the quantitatively detecting is performed using CARS, SERRS, or SERS.

22. A method of preparing an RSP, comprising:
(a) selecting a small organomolecule for use as an RSP by a process comprising:
(i) combining in solution a small organomolecule with a target sample under saturating binding-reaction conditions to yield a mixture containing a target-small organomolecule complex;
(ii) analyzing the target-small organomolecule complex using mass spectrometry, and
(iii) elucidating the small organomolecule's structure; and
(b) preparing the RSP by:
(i) synthesizing the selected small organomolecule if the structure contains at least one cyano, nitro, amide, ester, ether, olefin, sulphoxide, sulphite, sulphinic acid, sulphinic ester, sulphone, sulphonamide, thiol, carboxylic acid, or alkynyl group; or
(ii) synthesizing a cyano, nitro, amide, ester, ether, olefin, sulphoxide, sulphite, sulphinic acid, sulphinic ester, sulphone, sulphonamide, thiol, carboxylic acid, or alkynyl group analog of the small organomolecule if the structure does not contain any cyano, nitro, amide, ester, ether, olefin, sulphoxide, sulphite, sulphinic acid, sulphinic ester, sulphone, sulphonamide, thiol, carboxylic acid, or alkynyl group.

23. A method as defined in claim 22, further comprising performing a screening process a plurality of times in a parallel, high-throughput manner with different ligands to select the ligand for use as an RSP.

24. A method as defined in claim 22, wherein the screening process further comprises purifying the isolated complex prior to the analyzing.

25. A method as defined in claim 22, wherein the ligand is a small organomolecule.

26. A method as defined in claim 22, further comprising:
(c) using the RSP as an imaging reagent in a process comprising:
(i) administering the RSP to a subject;
(ii) obtaining a biological sample from the subject; and
(iii) quantitatively detecting for the presence of the RSP in the biological sample.

27. A method as defined in claim 26, wherein the quantitatively detecting is performed using Raman spectroscopy.

28. A method as defined in claim 26, wherein the quantitatively detecting is performed using CARS, SERRS, or SERS.

29. A method of converting a small organomolecule for use as an RSP, comprising:
(a) identifying a small organomolecule;
(b) synthesizing the small organomolecule if the small organomolecule contains a distinguishable Raman signal; or
(c) synthesizing an analog of the small organomolecule if the small organomolecule does not contain a distinguishable Raman signal.

30. A method as defined in claim 29, wherein the small organomolecule or the analog of the small organomolecule has one or more groups selected from cyano, nitro, amide, ester, ether, olefin, sulphoxide, sulphite, sulphinic acid, sulphinic ester, sulphone, sulphonamide, thiol, carboxylic acid, or alkynyl group.

31. A method as defined in claim 29, further comprising:
(c) using the RSP as an imaging reagent in a process comprising:
(i) administering the RSP to a subject;
(ii) obtaining a biological sample from the subject; and
(iii) quantitatively detecting for the presence of the RSP in the biological sample.

32. A method as defined in claim 31, wherein the quantitatively detecting is performed using Raman spectroscopy.

33. A method as defined in claim 31, wherein the quantitatively detecting is performed using CARS, SERRS, or SERS.

34. A method for detecting a target comprising:
(a) contacting the target with an RSP of claim 10;
(b) irradiating the target with a laser; and
(c) collecting and analyzing Raman spectra emitted from the target.

35. A method for detecting a target comprising:
(a) contacting the target with an RSP of claim 22;
(b) irradiating the target with a laser; and
(c) collecting and analyzing Raman spectra emitted from the target.

36. A method for detecting a target comprising:
(a) contacting the target with an RSP of claim 29;
(b) irradiating the target with a laser; and
(c) collecting and analyzing Raman spectra emitted from the target.
